(19) United States
(12) Patent Application Publication
(10) Pub. No.: US 2019/0313380 A1
(43) Pub. Date: Oct. 10, 2019

(54) Monitoring a Physical Downlink Control Channel for Downlink Control Information

(71) Applicant: Google LLC, Mountain View, CA (US)

(72) Inventor: Shiang-Rung Ye, New Taipei City (TW)

(73) Assignee: Google LLC, Mountain View, CA (US)

(21) Appl. No.: 16/360,251

(22) Filed: Mar. 21, 2019

Related U.S. Application Data
(60) Provisional application No. 62/653,399, filed on Apr. 5, 2018.

(51) Int. Cl. H04W 72/04; H04W 76/11; H04L 1/18; H04W 24/00

(52) U.S. Cl. CPC H04W 72/042; H04W 76/11; H04W 24/00; H04L 1/1887; H04L 1/1861; H04L 1/1812

(57) ABSTRACT

The present disclosure describes one or more aspects for monitoring a physical downlink control channel for downlink control information. Such aspects include receiving (605), by the user equipment (110) from a base station (120) and through a physical downlink shared channel (PDSCH) of an air interface, a first message that includes data and, upon receiving the first message, triggering (610) an act of monitoring a physical downlink control channel (PDDCH) of the air interface for a downlink control information (DCI) message. Upon receiving (615) the DCI message, the user equipment (110) transmits (620) a hybrid automatic request (HARQ) acknowledgment/not-acknowledgement (ACK/NACK) message through a physical uplink control channel (PUCCH) of the air interface. Upon transmitting the HARQ ACK/NACK message, the user equipment (110) cancels (625) the act of monitoring the PDCCH for the DCI message.

### BACKGROUND

Wireless communication has become a leading medium for accessing and receiving data. When a user equipment receives data from a base station of a wireless-communication network, such as a base station supporting a 5th Generation New Radio (5G NR) network, the user equipment relies on information in the form of downlink control information (DCI) received over a physical downlink control channel (PDCCH) to help the user equipment process and decode the data it receives.

In certain instances, the user equipment may receive an indication that the base station is preempting, or has preempted, a portion of data scheduled for transmission over resources associated with a physical downlink shared channel (PDSCH) of an air interface. The base station preempts the portion of the data so that the resources associated with the PDSCH can be reallocated for transmitting other data to another user equipment. In such instances, the user equipment must monitor the PDCCH for a DCI message that identifies one or more physical resource blocks (PRBs) or orthogonal frequency-division multiplexing (OFDM) symbols associated with the portion of the data that the base station is preempting.

Practices today, such as discontinuous reception (DRX) practices, do not clearly indicate when the user equipment should start or stop monitoring the PDCCH for the DCI message, potentially leading to undesirable consequences. For example, without a clear indication of when to start monitoring the PDCCH, the user equipment might be tardy for monitoring the PDCCH and miss receiving the DCI message. This may cause the user equipment to unsuccessfully process and decode data from the base station. As another example, without a clear indication of when to stop monitoring the PDCCH for the DCI message, the user equipment might monitor the PDCCH for an extended period of time, causing the user equipment to use excessive power and drain its battery resources.

### SUMMARY

The present disclosure describes one or more aspects for monitoring a physical downlink control channel (PDCCH) for a downlink control information (DCI) message. Such aspects may include triggering the monitoring of the PDCCH based on data received through a physical downlink shared channel (PDSCH) and canceling the monitoring of the PDCCH based on a determined uplink transmission condition. In some instances, this may improve detection of the DCI, as well as conserve power by canceling the monitoring of the PDCCH when such monitoring is no longer required.

In some aspects, a method performed by a user equipment is described. The method comprises the user equipment receiving, from a base station and through a first downlink channel of an air interface, a first message that includes data and triggering, based on receiving a first message that includes the data, an act of monitoring a second downlink channel of the air interface for a second message from the base station. The method also includes receiving, through a second downlink channel of the air interface and from the base station, the second message. As part of the method, the user equipment transmits, to the base station through a first uplink channel of the air interface, a third message. Based on the transmitted third message, the user equipment cancels the act of monitoring the second downlink channel for the second message.

In other aspects, another method for a user equipment is described. The method comprises the user equipment receiving, from a base station and through a first downlink channel of an air interface, a first message that includes data. Based on receiving the first message that includes the data, the user equipment triggers an act of monitoring a second downlink channel of the air interface for a second message. The method further includes the user equipment determining a timeout condition and, based on the determined timeout condition, canceling the act of monitoring the second downlink channel for the second message.

In other aspects, a user equipment is described. The user equipment comprises a processor and a computer-readable storage media. The computer-readable storage media comprises a downlink control information (DCI) manager that, upon execution by the processor, directs the user equipment to receive, from a base station and through a first downlink channel of an air interface, a first message that includes data, and to trigger, based on receiving the first message that includes the data, an act of monitoring a second downlink channel of the air interface for a second message that is transmitted by the base station. The user equipment is further directed to receive, through the second downlink channel of the air interface and from the base station, the second message and to transmit, to the base station through a first uplink channel of the air interface, a third message. The user equipment is also directed to cancel, based on the transmitted third message, the act of monitoring the second downlink channel for the second message.

The details of one or more implementations are set forth in the accompanying drawings and the following description. Other features and advantages will be apparent from the description and drawings, and from the claims. This summary is provided to introduce subject matter that is further described in the Detailed Description and Drawings. Accordingly, a reader should not consider the summary to describe essential features nor limit the scope of the claimed subject matter.

### BRIEF DESCRIPTION OF THE DRAWINGS

This document describes details of one or more aspects for monitoring a physical downlink channel (PDCCH) for a downlink control information (DCI) message. The use of the same reference numbers in different instances in the description and the figures may indicate like elements:

FIG. 1 illustrates an example operating environment in accordance with one or more aspects of monitoring a physical downlink control channel for downlink control information.

FIG. 2 illustrates example device diagrams in accordance with one or more aspects of monitoring a physical downlink control.

FIG. 3 illustrates example details of an air interface in accordance with monitoring a physical downlink control channel for downlink control information.

FIG. 4 illustrates an example method that a user equipment performs in accordance with one or more aspects of monitoring a physical downlink control channel for downlink control information.

FIG. 5 illustrates another example method that a user equipment performs in accordance with one or more aspects of monitoring a physical downlink control channel for downlink control information.

FIG. 6 illustrates an example signaling and control transaction diagram in accordance with one or more aspects of monitoring a physical downlink control channel for downlink control information.

FIG. 7 illustrates another signaling and control transaction diagram in accordance with one or more aspects of monitoring a physical downlink control channel for downlink control information.

### DETAILED DESCRIPTION

The present disclosure describes one or more aspects for monitoring a physical downlink control channel for downlink control information. Such aspects include receiving, by a user equipment from a base station and through a physical downlink shared channel (PDSCH) of an air interface, a first message that includes data, and triggers the user equipment to perform an act of monitoring a physical downlink control channel (PDDCH) of the air interface for a downlink control information (DCI) message. Upon receiving the DCI message, the user equipment transmits a hybrid automatic request (HARQ) acknowledgment/not-acknowledgement (ACK/NACK) message through a physical uplink control channel (PUCCH) of the air interface. Upon transmitting the HARQ ACK/NACK message, the user equipment cancels the act of monitoring the PDCCH for the DCI message.

While supporting a wireless-communication network, resources of an air interface that correspond to physical downlink shared channel (PDSCH) may support transmission of data from a base station to a user equipment. In certain instances, a base station manager may reprioritize and reschedule the resources (e.g., the resources of the air interface corresponding to the PDSCH). Such reprioritizing and the rescheduling may be in response to a request from the other user equipment, network congestion management needs, and so forth.

From a perspective of a user equipment, maintaining an accurate and contemporary understanding of resource allocation is necessary to process and decode data intended for the user equipment. In order to maintain an accurate and contemporary understanding of resource allocations, the user equipment can monitor a physical downlink control channel (PDCCH) for indicators that flag resources that are no longer intended for the user equipment. Such indicators are typically included in a downlink control information (DCI) message.

As an example, and as part of a Fifth-Generation New Radio (5G NR) network, a next generation node B (gNB) base station can preempt a downlink transmission of data to the user equipment. In doing so, and as a part of preempting the downlink transmission of the data, the gNB base station may reallocate resources that had been scheduled for the downlink transmission of the data. To notify the user equipment of the reallocation, the gNB base station sends to the user equipment, through the PDCCH, a DCI message formatted according to a DCI 2_1 format. The DCI 2_1 format includes a field which indicates which orthogonal frequency-division multiplexing (OFDM) symbols are preempted. Upon receiving the DCI message, the user equipment flushes received data corresponding to the preempted OFDM symbols. Subject to receiving the DCI message, which requires the user equipment monitoring the PDCCH, the user equipment may process received data that it has not flushed to determine the HARQ response.

Under certain retransmission conditions, the user equipment can cancel monitoring the PDCCH for the DCI message. One such uplink transmission condition can include the user equipment transmitting a hybrid automatic request (HARQ) acknowledgment/not-acknowledge (ACK/NACK) message to the base station. Under this condition, the HARQ ACK/NACK message may include a status of decoding of received data and, in some instances, a request for a retransmission of the data. The retransmission is transmitted along with another DCI message, so the user equipment can cancel monitoring for the original DCI message relating to the associated data. Another such condition can include expiration of a set time period. This document describes techniques and methods for triggering and canceling monitoring of the PDCCH for the DCI message in accordance with these conditions.

### Operating Environment

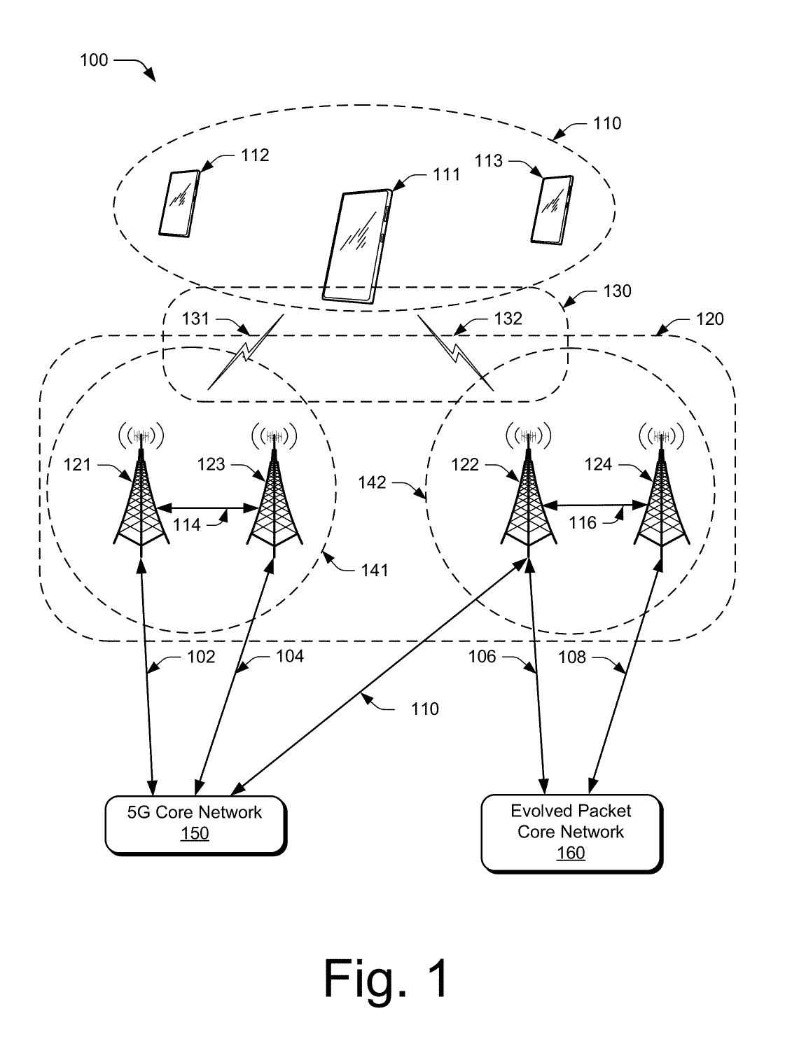

FIG. 1 illustrates an example operating environment 100 in accordance with one or more aspects of monitoring a physical downlink control channel for downlink control information. The operating environment 100 includes a user equipment 110 (UE 110), which can communicate with one or more base stations 120 (illustrated as base stations 121, 122, 123, and 124) through one or more wireless-communication links 130 (wireless link 130), as wireless links 131 and 132. In this example, the UE 110 is a smartphone. Although implemented as a smartphone, the UE 110 may be any suitable computing or electronic device, such as a mobile communication device, a modem, cellular phone, gaming device, navigation device, media device, laptop computer, desktop computer, tablet computer, smart appliance, vehicle-based communication system, and the like. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, or the like, or any combination thereof.

The base stations 120 communicate with the UE 110 through the wireless links 131 and 132, which may be implemented as any suitable type of wireless link. The wireless link 131 and 132 can include a downlink of data and control information communicated from the base stations 120 to the UE 110, an uplink of other data and control information communicated from the UE 110 to the base station(s) 120, or both. The wireless links 130 may include one or more wireless links or bearers implemented using any suitable communication protocol or standard, or combination of communication protocols or standards such as Third-Generation Partnership Project Long-Term Evolution (3GPP LTE), Fifth-Generation New Radio (5G NR), and so forth. Multiple wireless links 130 may be aggregated in a carrier aggregation to provide a higher data rate for the UE 110. Multiple wireless links 130 from multiple base stations 120 may be configured for Coordinated Multipoint (CoMP) communication with the UE 110.

The base stations 120 are collectively a Radio Access Network 140 (RAN, Evolved Universal Terrestrial Radio Access Network, E-UTRAN, 5G NR RAN or NR RAN). The RANs 140 are illustrated as a NR RAN 141 and an E-UTRAN 142. The base stations 121 and 123 in the NR RAN 141 are connected to a Fifth-Generation Core 150 (5GC 150) network. The base stations 122 and 124 in the E-UTRAN 142 are connected to an Evolved Packet Core 160 (EPC 160). Optionally or additionally, the base station 122 may connect to both the 5GC 150 and EPC 160 networks.

The base stations 121 and 123 connect, at 102 and 104 respectively, to the 5GC 150 through an NG2 interface for control-plane signaling and through an NG3 interface for user-plane data communications. The base stations 122 and 124 connect, at 106 and 108 respectively, to the EPC 160 through an Si interface for control-plane signaling and user-plane data communications. Optionally or additionally, if the base station 122 connects to the 5GC 150 and EPC 160 networks, the base station 122 connects to the 5GC 150 through an NG2 interface for control-plane signaling and through an NG3 interface for user-plane data communications, at 180.

In addition to connections to core networks, base stations 120 may communicate with each other. The base stations 121 and 123 communicate through an Xn interface at 114. The base stations 122 and 124 communicate through an X2 interface at 116.

In certain instances, the UE 110 wirelessly communicates with the base station 120 through the wireless link 130. During such wireless communications, the UE 110, may receive data through a downlink channel of an air interface and, based on the received data, trigger monitoring of another downlink channel for a message. Based on another message transmitted from the UE 110 to the base station 110 condition, the UE 110 may cancel the act of monitoring of the other channel for the message.

### Example Systems

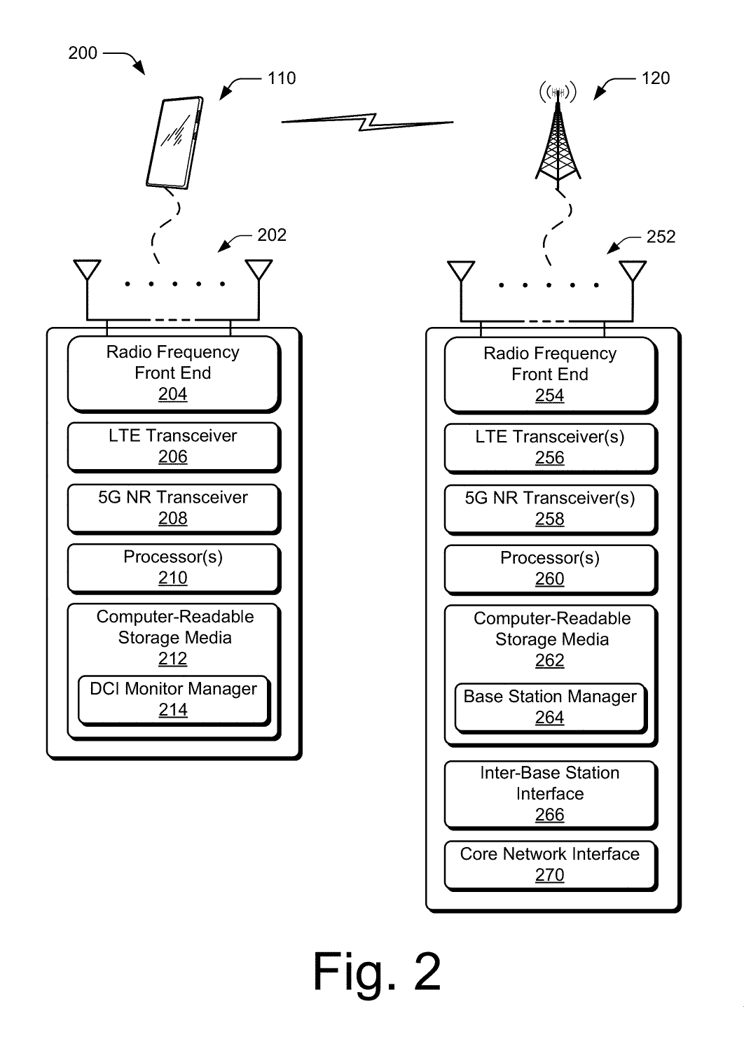

FIG. 2 illustrates an example device diagram 200 of the multiple UE 110 and the base stations 120. The multiple UE 110 and the base stations 120 may include additional functions and interfaces that are omitted from FIG. 2 for the sake of clarity. The UE 110 includes antennas 202, a radio frequency front end 204 (RF front end 204), an LTE transceiver 206, and a 5G NR transceiver 208 for communicating with base stations 120 in the 5G RAN 141 and/or the E-UTRAN 142. The RF front end 204 of the UE 110 can couple or connect the LTE transceiver 206, and the 5G NR transceiver 208 to the antennas 202 to facilitate various types of wireless communication. The antennas 202 of the UE 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards.

The UE 110 also includes processor(s) 210 and computer-readable storage media 212 (CRM 212). The processor 210 may be a single core processor or a multiple core processor composed of a variety of materials, such as silicon, polysilicon, high-K dielectric, copper, and so on. The computer-readable storage media described herein excludes propagating signals. The CRM 212 may include any suitable memory or storage device such as random-access memory (RAM), static RAM (SRAM), dynamic RAM (DRAM), non-volatile RAM (NVRAM), read-only memory (ROM), or Flash memory.

The CRM 212 also includes a downlink control information (DCI) monitor manager 214 having executable code. Alternately or additionally, the DCI monitor manager 214 may be implemented in whole or part as hardware logic or circuitry integrated with or separate from other components of the UE 110. In at least some aspects, executing the code of the DCI monitor manager 214 directs the UE 110 to perform multiple functions, examples of which include receiving data through a physical downlink shared channel (PDSCH) and triggering, based on the received data, the monitoring of (e.g., receiving and decoding of signals of) a physical downlink control channel (PDCCH) for a downlink control information (DCI) message. The DCI message may include information associated with resources of an air interface, modulation schemes, or power control that is pertinent to downlink communications from the base station 120 to the UE 110. In certain instances, the DCI message may include a radio network temporary identifier (RNTI) that identifies the DCI message to the UE 110.

The DCI monitor manager 214 may include executable code that directs the UE 110 to assess or more uplink transmission conditions that are local to the UE 110 and, based on an assessed uplink transmission condition, cancel the monitoring of the PDCCH. As an example, if the UE 110 assesses it has transmitted a hybrid automatic repeat request acknowledgment or non-acknowledgment (HARQ ACK/NACK) message to the base station 120, the UE 110 may determine that the data (e.g., the data included in the first message) has been received and that an updating of downlink control information is not needed from the base station 120.

In some instances, the DCI monitor manager 214 may include executable code that directs the UE 110 to monitor wireless communications between the base station 120 and the UE 110 to determine a timeout condition. Such a timeout condition may be associated to a time period between the UE 110 receiving a message through the PDSCH channel and transmitting a HARQ ACK/NACK message through the PUCCH channel (e.g., a “PDSCH-to-HARQ feedback time”). Such a timeout condition may indicate that an allowable duration of a time for the UE 110 to receive a message through the PDCCH channel (e.g., a DCI message) has expired. Alternatively, the timeout condition may indicate that an allowable duration of time for the UE 110 to transmit a message through the PUCCH channel (e.g., a HARQ ACK/NACK message) has expired.

The device diagram for the base station 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the UE 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency bands defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with the UE 110.

The base stations 120 also include processor(s) 260 and computer-readable storage media 262 (the CRM 262). The processor 260 may be a single core processor or a multiple core processor composed of a variety of materials, such as silicon, polysilicon, high-K dielectric, copper, and so on. The CRM 262 may include any suitable memory or storage device such as random-access memory (RAM), static RAM (SRAM), dynamic RAM (DRAM), non-volatile RAM (NVRAM), read-only memory (ROM), or Flash memory.

The CRM 262 also includes a base station manager 264 having executable code. Alternately or additionally, the base station manager 264 may be implemented in whole or part as hardware logic or circuitry integrated with or separate from other components of the base stations 120. In at least some aspects, executing the code of the base station manager 264 may allocate resources of a radio access network (e.g., resources corresponding to an air interface that conforms to a 3GPP LTE or a 5G NR wireless-communication protocol standard) and also configure the LTE transceivers 256 and the 5G NR transceivers 258 for communication with the UE 110 in accordance with monitoring a physical downlink control channel for downlink control information as described herein.

The base stations 120 include an inter-base station interface 266, such as an Xn and/or X2 interface, which the base station manager 264 configures to exchange user-plane and control-plane data between another base station 120, to manage the communication of the base stations 120 with the UE 110. The base stations 120 include a core network interface 268 that the base station manager 264 configures to exchange user-plane and control-plane data with core network functions and entities.

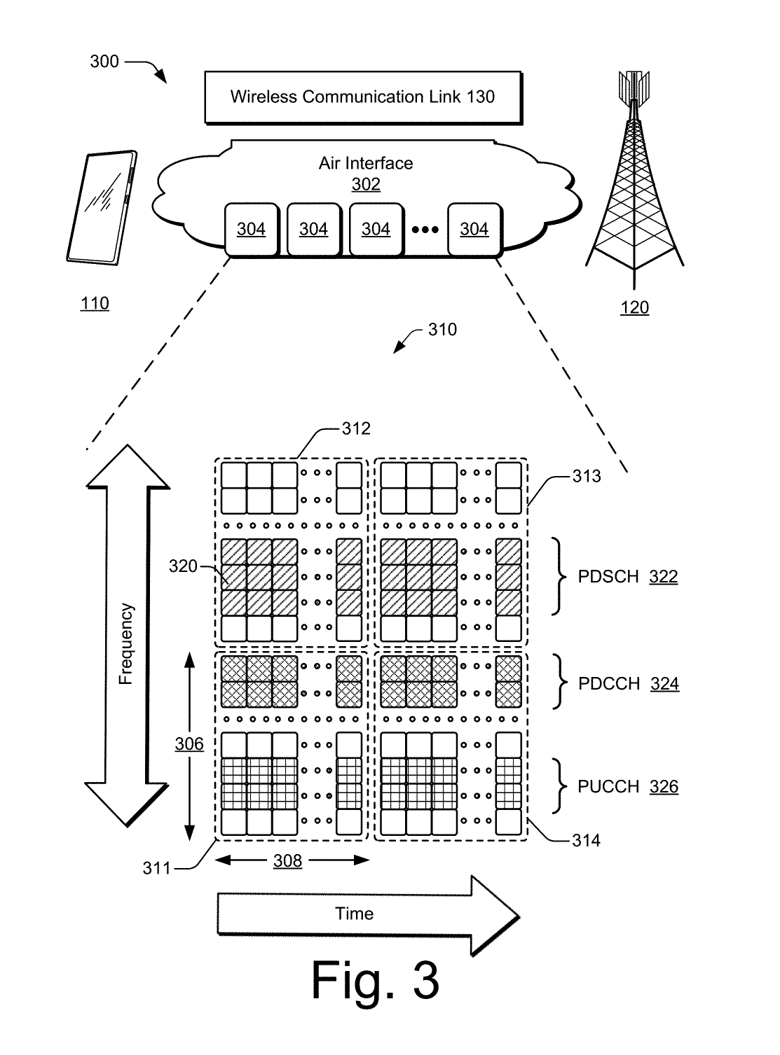

FIG. 3 illustrates example details 300 of an air interface in accordance with monitoring a physical downlink control channel for downlink control information. The air interface 302 can be divided into resource units 304, each of which occupies some intersection of frequency spectrum and elapsed time. A portion of the air interface 302 is illustrated graphically in a grid or matrix having multiple resource blocks 310, including example resource blocks 311, 312, 313, 314. An example of a resource unit 304 therefore includes at least one resource block 310. As shown, time is depicted along the horizontal dimension as the abscissa axis, and frequency is depicted along the vertical dimension as the ordinate axis. The air interface 302, as defined by a given communication protocol or standard, may span any suitable specified frequency range, and/or may be divided into intervals of any specified duration. Increments of time can correspond to, for example, milliseconds (mSec). Increments of frequency can correspond to, for example, megahertz (MHz).

In example operations generally, the base station 120 allocates portions (e.g., resource units 304) of the air interface 302 for uplink and downlink communications. Each resource block 310 of network access resources may be allocated to support the respective wireless-communication link 130 of multiple user equipment 110. In the lower left corner of the grid, the resource block 311 may span, as defined by a given communication protocol, a frequency range 306 and comprise multiple subcarriers or frequency sub-bands. The resource block 311 may include any suitable number of subcarriers (e.g., 12) that each correspond to a respective portion (e.g., 15 kHz) of the frequency range 306 (e.g., 180 kHz). The resource block 311 may also span, as defined by the given communication protocol, a time interval 308 or time slot (e.g., lasting approximately one-half millisecond or 7 orthogonal frequency division multiplexing (OFDM) symbols). The time interval 308 includes subintervals that may each correspond to a symbol, such as an OFDM symbol. As shown in FIG. 3, each resource block 310 may include multiple resource elements 320 (REs) that correspond to, or are defined by, a subcarrier of the frequency range 306 and a subinterval (or symbol) of the time interval 308. Alternatively, a given resource element 320 may span more than one frequency subcarrier or symbol. Thus, a resource unit 304 may include at least one resource block 310, at least one resource element 320, and so forth.

In example implementations, the UE 110 may communicate with the base station 120 using resources of the air interface 302 that the base station 120 (e.g., the processor 260 executing the code of the base station manager 264) allocates as part of a wireless networking stack. As an example, and as part of a physical layer of 5G NR wireless networking stack, resources (e.g., a set of multiple resource elements 320) may be allocated for a physical downlink shared channel (e.g., the PDSCH 322), other resources (e.g., another set multiple resource elements 320) may be allocated for a physical downlink control channel (e.g., the PDCCH 324), and yet other resources (e.g., yet another set multiple resource elements 320) may be allocated for a physical uplink control channel (e.g., the PUCCH 326). Although the allocation of resources in FIG. 3 is illustrated at a granularity corresponding to the resource element 320, the allocation of resources may take place at other granularities, including granularities corresponding to the resource block 310. In some instances, a message including a set of data may be transmitted from the base station 120 to the UE 110 through the PDSCH 322, another message including downlink control information (DCI) may be transmitted from the base station 120 to the UE 110 through the PDCCH 324, and another message including a hybrid automatic repeat request (HARQ) acknowledgment or a non-acknowledgment (ACK/NACK) may be transmitted from the UE 110 to the base station 120 through the PUCCH 326.

### Example Methods

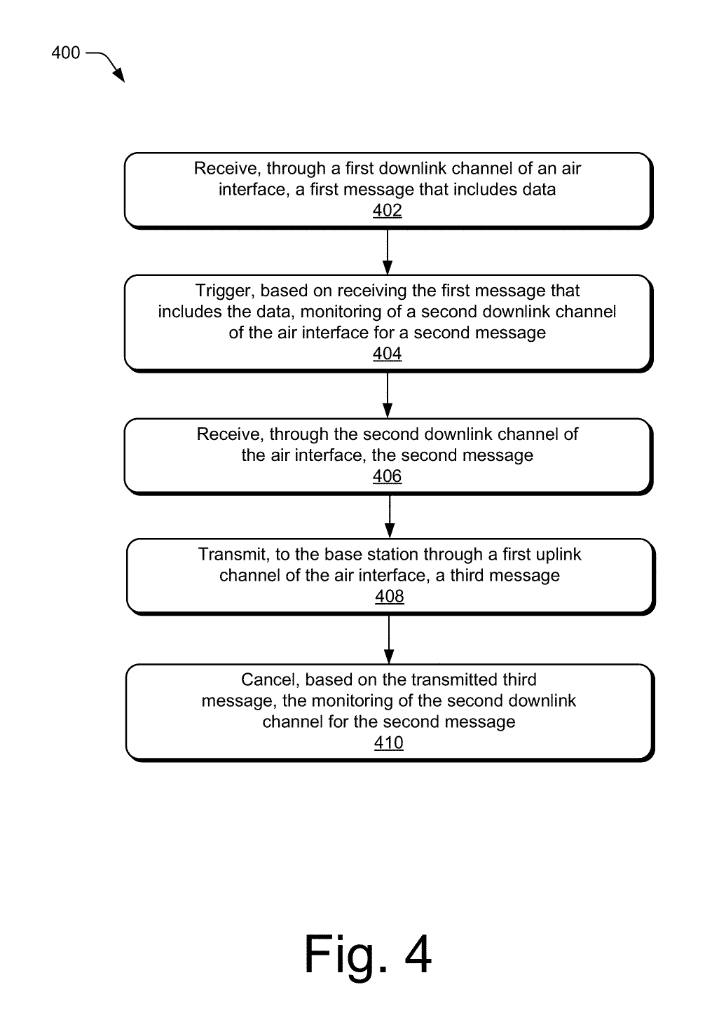

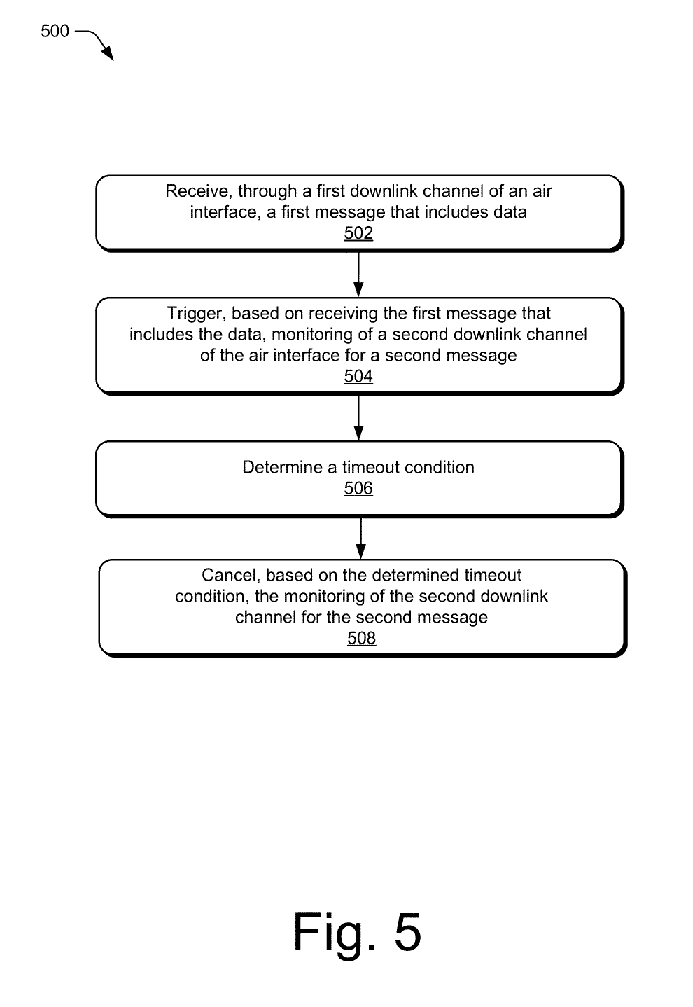

Example methods 400 and 500 are described with reference to FIGS. 4 and 5 in accordance with one or more aspects of monitoring a physical downlink control channel for downlink control information. The order in which the method blocks are described are not intended to be construed as a limitation, and any number of the described method blocks can be combined in any order or skipped to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (AS SPs), System-on-a-chip systems (SoCs), Complex Programmable Logic Devices (CPLDs), and the like.

FIG. 4 illustrates an example method 400 that a user equipment performs in accordance with one or more aspects of monitoring a physical downlink control channel for downlink control information. The user equipment may be the UE 110, wherein the processor 210 executes the code of the DCI monitor manager 214 to direct the UE 110 to perform the operations of the method 400 as detailed below.

At operation 402 the user equipment receives, from a base station (e.g., the base station 120) and through a first downlink channel of an air interface (e.g., the air interface 302) a first message that includes data. The first downlink channel of the air interface may be a physical downlink shared channel (e.g., the PDSCH 322) and the air interface may be an air interface that conforms with a Third-Generation Partnership Project Long-Term Evolution (3GPP LTE), a Fifth-Generation New Radio (5G NR), or a Sixth-Generation (6G) wireless-communication protocol.

At operation 404, based on receiving the first message that includes the data, the user equipment triggers an act of monitoring a second downlink channel of the air interface for a second message from the base station. The second downlink channel of the air interface may be a physical downlink control channel (e.g., the PDCCH 324) and second message may be a downlink control information (DCI message).

At operation 406, the user equipment receives the second message through the second downlink channel of the air interface. The second message, in some aspects, may comprise several aspects of information or indicators. In one aspect, the second message may include information that is a radio network temporary identifier (RNTI) that identifies the second message to the user equipment. In another aspect, the second message may be a format (e.g., a DCI 2_1 format) that indicates a preemption of other data to the user equipment (e.g., the base station may intend the other data for another user equipment). In this other aspect, the second message may include information that indicates to the user equipment resources of the air interface (e.g., the resource block 310) and orthogonal frequency-division multiplexing (OFDM) symbols associated with other data that is preempted, providing the user equipment the ability to not monitor the indicated resources and/or flush the other data associated with the OFDM symbols.

At operation 408, the user equipment transmits, through a first uplink channel of the air interface, a third message. In some instances, the uplink channel may be a physical uplink control channel (e.g., the PUCCH 326). The third message may be a hybrid automatic repeat request (HARQ) acknowledgment (ACK) or a non-acknowledgment (NACK) message that indicates a status of the user equipment decoding the data included in the first message. In an instance where the user equipment is not able to decode the data included the first message, the third message may include a soft-combining of the data included in the first message with other data that is stored in a HARQ buffer.

At operation 410, and based on the transmitted third message, the user equipment may cancel the monitoring of the second downlink channel for the second message.

FIG. 5 illustrates another example method 500 that a user equipment performs in accordance with one or more aspects of monitoring a physical downlink control channel for downlink control information. The user equipment may be the UE 110, wherein the processor 210 executes the code of the DCI monitor manager 214 to direct the UE 110 to perform the operations of the method 400 as detailed below.

At operation 502 the user equipment receives, from a base station (e.g., the base station 120) and through a first downlink channel of an air interface (e.g., the air interface 302) a first message that includes data. The first downlink channel of the air interface may be a physical downlink shared channel (e.g., the PDSCH 322) and the air interface may be an air interface that conforms with a Third-Generation Partnership Project Long-Term Evolution (3GPP LTE), a Fifth-Generation New Radio (5G NR), or a Sixth-Generation (6G) wireless-communication protocol.

At operation 504, based on receiving the first message that includes the data, the user equipment triggers an act of monitoring a second downlink channel of the air interface for a second message from the base station. The second downlink channel of the air interface may be a physical downlink control channel (e.g., the PDCCH 324) and second message may be a downlink control information (DCI message).

At operation 506, the user equipment determines a timeout condition. A first example of the timeout condition is a timeout condition that indicates an allowable duration of time for transmitting a third message, by the user equipment and to the base station after receipt of the first message by the user equipment, has expired. Such a third message may be a hybrid automatic repeat request (HARQ) acknowledgment (ACK)/non-acknowledgment (NACK) message that indicates a status of the user equipment decoding the data included in the first message. In an instance where the user equipment is not able to decode the data included the first message, the third message may include a soft-combining of the data included in the first message with other data that is stored in a HARQ buffer.

A second example of the timeout condition at operation 506 is a timeout condition that indicates that an allowable duration of time for the user equipment to receive the second message from the base station has expired. The second message may be downlink control information (DCI) message.

At operation 508 the user equipment cancels, based on the determined timeout condition, the monitoring of the second downlink channel for the second message.

### Signaling and Control Transactions

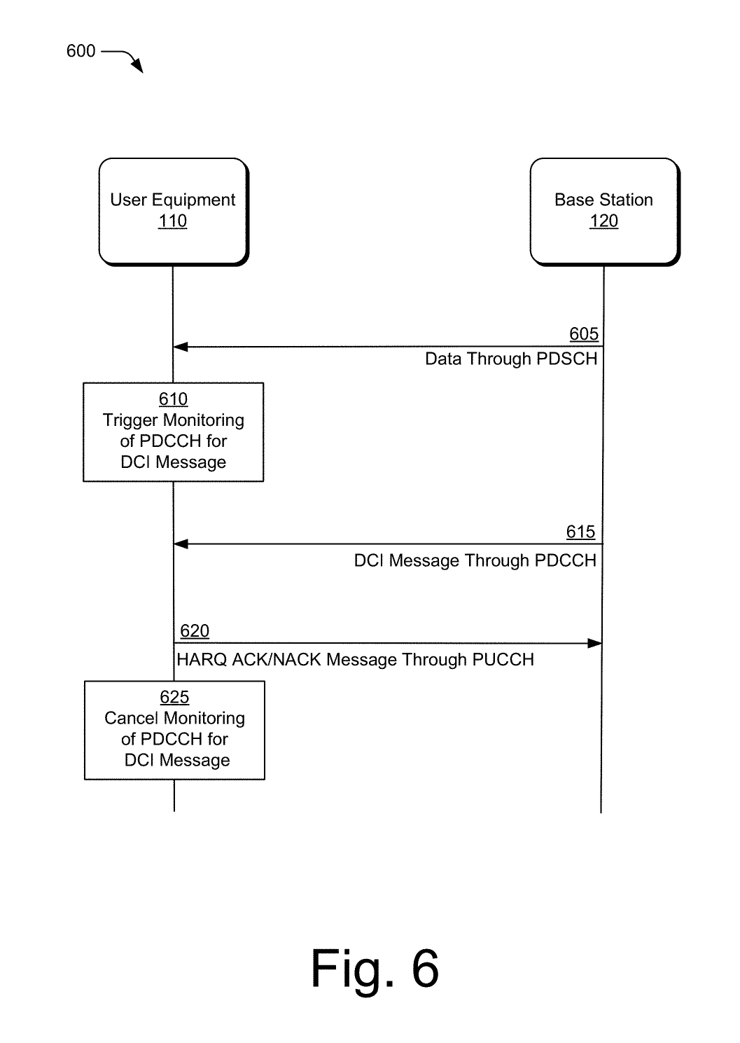

FIG. 6 illustrates details 600 of example signaling and control transactions in accordance with one or more aspects of monitoring a physical downlink control channel for downlink control information. Although multiple combinations and permutations of monitoring a physical downlink control channel for downlink control information are possible, FIG. 6 is illustrated in the context of a user equipment (e.g., the user equipment 110) communicating with a base station (e.g., the base station 120 of FIG. 1).

At 605, the base station 120 transmits a first message to the UE 110 through a physical downlink shared channel (PDSCH) of an air interface. The first message includes data and triggers (at 610) the UE 110 to monitor a physical downlink control channel (PDCCH) of the air interface for a second message.

At 615, the base station 120 transmits the second message (e.g., the DCI message) to the UE 110. The second message, a downlink control information (DCI) message, may include information that is a radio network temporary identifier (RNTI) that identifies the second message to the user equipment. In some instances, the second message may be a format (e.g., a DCI 2_1 format) that preempts the other data to the user equipment (e.g., the base station may intend the other data for another user equipment). In such instances, the second message may include information that indicates to the user equipment resources of the air interface (e.g., the resource block 310) and orthogonal frequency-division multiplexing (OFDM) symbols associated with the other data, providing the user equipment the ability to not monitor the indicated resources and/or flush the other data associated with the OFDM symbols.

In response, at 620, the UE 110 transmits, through a physical uplink control channel (PUCCH) of the air interface, a third message. The third message, a hybrid automatic repeat request (HARQ) acknowledgment (ACK) or non-acknowledgment (NACK) message, indicates a status of the user equipment decoding the data included in the first message. In an instance where the UE 110 is not able to decode the data included the first message, the third message may include a soft-combining of the data included in the first message with other data that is stored in a HARQ buffer. In response to transmitting the third message (e.g., the HARQ ACK/NACK message), the UE 110 cancels (at 625) the act of monitoring the PDCCH for the DCI message.

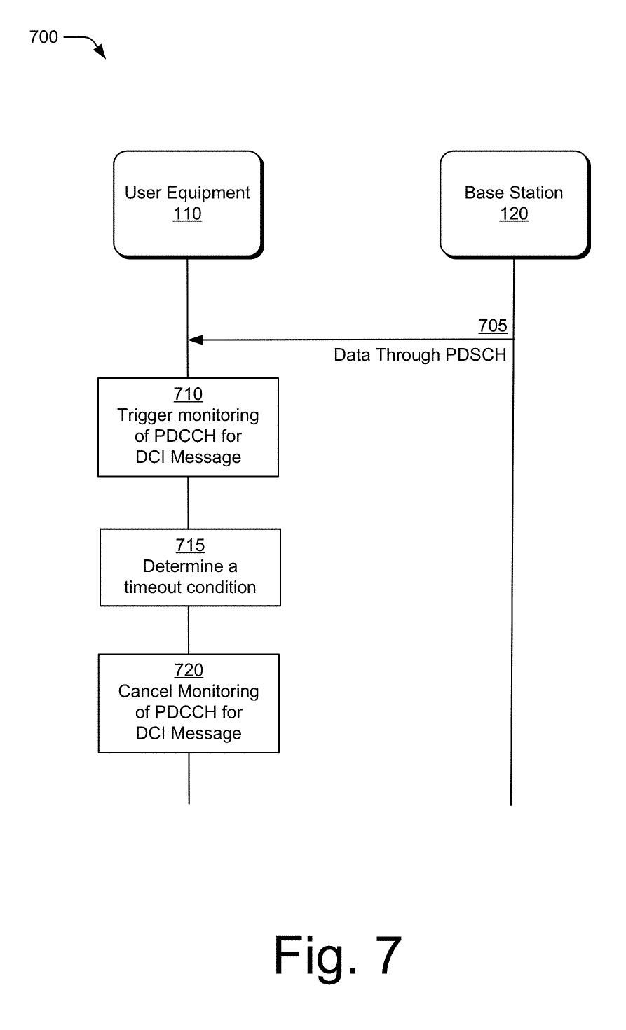

FIG. 7 illustrates details 700 of example signaling and control transactions in accordance with one or more aspects of monitoring a physical downlink control channel for downlink control information. Although multiple combinations and permutations of monitoring a physical downlink control channel for downlink control information are possible, FIG. 7 is illustrated in the context of a user equipment (e.g., the user equipment 110) communicating with a base station (e.g., the base station 120 of FIG. 1).

At 705, the base station 120 transmits a first message to the UE 110 through a physical downlink shared channel (PDSCH) of an air interface. The first message includes data and triggers (710) the UE 110 to monitor a physical downlink control channel (PDCCH) of the air interface for a second message, wherein the second message is a downlink control information (DCI) message.

At 710, the UE 110 determines a timeout condition. A first example of the timeout condition is a timeout condition that indicates an allowable duration of time for transmitting a third message, by the user equipment and to the base station after receipt of the first message by the user equipment, has expired. Such a third message may be a hybrid automatic repeat request (HARQ) acknowledgment (ACK)/non-acknowledgment (NACK) message that indicates a status of the user equipment decoding the data included in the first message. A second example of the timeout condition at operation 506 is a timeout condition that indicates that an allowable duration of time for the user equipment to receive the DCI message from the base station has expired.

At 720, and based on the determined timeout condition at 710, the UE 110 cancels the act of monitoring the PDCCH for the DCI message.

### Variations

The aforementioned systems and methods can accommodate additional variations associated with monitoring a physical downlink control channel for downlink control information. As one example variation, consider an instance where the user equipment is receiving multiple messages through the PDSCH and multiple, respective DCI messages through the PDCCH. In such an instance, the user equipment may assess transmission of the HARQ ACK/KNACK message for each respective message received through the PDSCH and, in accordance with each HARQ ACK/KNACK message, adjust monitoring of the PDCCH for respective DCI messages. For example, based on the user equipment assessing uplink transmission conditions for two messages received through the PDSCH, the user equipment may cancel monitoring the PDCCH for a first DCI message associated with a first of the two messages received through the PDSCH, but continue monitoring the PDCCH for a second DCI message associated with a second of the two messages received through the PDSCH. The user equipment may alternatively, or in combination, determine a timeout condition associated with either transmission of respective HARQ ACK/KNACK messages or receipt of respective DCI messages and adjust monitoring of the PDCCH accordingly.

Another example variation includes the user equipment wirelessly communicating in a multi-connectivity, multi radio access technology (RAT) environment. For example, the user equipment may be wirelessly connected to a first base station using a 3GPP LTE radio access technology and connected to a second base station using a 5G NR radio access technology. In such an instance the user equipment may, using permutations of the aforementioned methods and systems, perform operations that include (i) receiving respective messages through respective PDSCH channels of the 3GPP LTE RAT and the 5G NR RAT, (ii) triggering monitoring of respective PDCCH channels of the 3GPP LTE RAT and the 5G NR RAT for respective DCI messages, (iii) determining respective uplink transmission conditions for 3GPP LTE RAT and the 5G NR RAT, and (iv) cancel the monitoring of the respective PDCCH channels of the 3GPP LTE RAT and the 5G NR RAT for the respective DCI messages.

Although techniques using, and apparatuses for monitoring a physical downlink control channel for downlink control information are described, it is to be understood that the subject of the appended claims is not necessarily limited to the specific features or methods described. Rather, the specific features and methods are disclosed as example ways in which monitoring a physical downlink control channel for downlink control information can be implemented.

What is claimed is:

1. A method performed by a user equipment, the method comprising:
receiving, by the user equipment from a base station and through a first downlink channel of an air interface, a first message that includes data;
triggering, based on receiving the first message that includes the data, an act of monitoring a second downlink channel of the air interface for a second message from the base station;
receiving, through the second downlink channel of the air interface and from the base station, the second message;
transmitting, to the base station through a first uplink channel of the air interface, a third message; and
canceling, based on the transmitted third message, the act of monitoring the second downlink channel for the second message.

2. The method as recited in claim 1, wherein the first downlink channel is a physical downlink shared channel (PDSCH).

3. The method as recited in claim 1, wherein the second downlink channel is a physical downlink control channel (PDCCH).

4. The method as recited in claim 1, wherein the second message is a downlink control information (DCI) message that is identified to the user equipment using a radio network temporary identifier (RNTI).

5. The method as recited in claim 4, wherein a format of the DCI message corresponds to a DCI 2_1 format.

6. The method as recited in claim 1, wherein the second message indicates a preemption of other data to the user equipment on the first downlink.

7. The method as recited in claim 6, wherein the second message indicates orthogonal frequency-division multiplexing (OFDM) symbols associated with the other data.

8. The method as recited in claim 1, wherein the third message is a hybrid automatic repeat request (HARQ) acknowledgment (ACK) or non-acknowledgment (NACK) message.

9. The method as recited in claim 8, wherein the HARQ ACK/KNACK message:
indicates a status of the user equipment decoding the data included in the first message; or
includes a soft-combining of the data included in the first message with other data stored in a HARQ buffer.

10. The method as recited in claim 1, wherein the first uplink channel of the air interface is a Physical Uplink Control Channel (PUCCH).

11. A method performed by a user equipment, the method comprising:
receiving, by the user equipment from a base station and through a first downlink channel of an air interface, a first message that includes data;
triggering, by the user equipment and based on the received first message that includes the data, an act of monitoring a second downlink channel of the air interface for a second message;
determining, by the user equipment, a timeout condition; and
canceling, based on the determined timeout condition, the act of monitoring the second downlink channel for the second message.

12. The method as recited in claim 11, wherein the first downlink channel is a physical downlink shared channel (PDSCH).

13. The method as recited in claim 11, wherein the second downlink channel is a physical downlink control channel (PDCCH).

14. The method as recited in claim 11, wherein the timeout condition indicates that an allowable duration of a time for the user equipment to receive the second message from the base station has expired.

15. The method as recited in claim 11, wherein the second message indicates a preemption of other data to the user equipment on the first downlink.

16. The method as recited in claim 11, wherein the timeout condition indicates that an allowable duration of time for transmitting a third message, by the user equipment and to the base station after receipt of the first message by the user equipment, has expired.

17. The method as recited in claim 16, wherein the third message is a hybrid automatic repeat request (HARQ) acknowledgment (ACK) or a non-acknowledgment (NACK) message that:
indicates a status of the user equipment decoding the data included in the first message; or
includes a soft-combining of the data included in the first message with other data stored in a HARQ buffer.

18. A user equipment comprising
a processor; and
a computer-readable storage media comprising a downlink control information (DCI) manager that, upon execution by the processor, direct the user equipment to:
receive, from a base station and through a first downlink channel of an air interface, a first message that includes data;
trigger, based on receiving the first message, an act of monitoring a second downlink channel of the air interface for a second message that is transmitted by the base station;
receive, through the second downlink channel of the air interface and from the base station, the second message;
transmit, to the base station through a first uplink channel of the air interface, a third message; and
cancel, based on the transmitted third message, the act of monitoring the second downlink channel for the second message.

19. The user equipment as recited in claim 18, wherein execution of the downlink control information (DCI) manager further directs the user equipment to:
determine that a duration of time for the user equipment to receive the second message from the base station has expired and cancel the monitoring of the second downlink channel for the second message.

20. The user equipment as recited in claim 19, wherein the air interface conforms to a Third-Generation Partnership Project Long-Term Evolution (3GPP LTE), a Fifth-Generation New Radio (5G NR), or a Sixth-Generation (6G) wireless-communication protocol.
